(19) United States
(12) Patent Application Publication
(10) Pub. No.: US 2003/0145703 A1
(43) Pub. Date: Aug. 7, 2003

(54) Device for the three-sided trimming of printed products

(76) Inventor: Ansgar Rohe-Krebeck, Steinfeld-Muhlen (DE)

Correspondence Address: ALIX YALE & RISTAS LLP, 750 MAIN STREET, SUITE 1400, HARTFORD, CT, 06103, US

(21) Appl. No.: 10/355,999

(22) Filed: Jan. 31, 2003

(30) Foreign Application Priority Data
Feb. 2, 2002 (DE) 102 04 296.9

(51) Int. Cl. B26D 7/06

(52) U.S. Cl. 83/277; 83/934

(57) ABSTRACT

In a device for the three-sided trimming of book blocks, adhesively bound or wire saddle-stitched paper covers and like printed products (1), the said device having separate cutting stations (22, 27), which are disposed one behind another in a direction of conveyance (F), for the front and head/foot trims, the said direction of conveyance (F) being orientated perpendicularly to the height of the block and perpendicularly to the front-trimming plane; having cutting tables (23, 28) on which the printed products (1) rest, at least partially, during trimming; having knives (25, 30) which are moved up and down and which operate against cutting strips (23a, 28a) fixed in the cutting tables (23, 28) or against lower knives; having pressing beams (24, 29) for pressing the printed products (1) against the cutting tables (23, 28); and having a transporting system (13) which connects at least the two cutting stations (22, 27) and clamps-in the printed products (1) in the process, there are provided a gripper (18) which grasps the printed products (1) at the back (1c) and transports them with the back (1c) foremost, is guided in a plane between the cutting planes of the head/foot-trimming station (22) and effects conveyance through the cutting plane of the front-trimming station (27); and a cutting table (28, 28a) which is associated with the front-trimming station (27) and can be moved to and fro, the said cutting table freeing the transporting path (T) of the gripper (18) during the transporting of the printed products (1) into the front-trimming station (27).

### BACKGROUND OF THE INVENTION

The invention relates to a device for the three-sided trimming of book blocks, adhesively bound or wire saddle-stitched paper covers and like printed products, the said device being constructed in accordance with the pre-characterising clause of claim 1.

Devices of the aforesaid type are also referred to as “three-cutter machines” or “trimmers”. [Liebau, Heinze/Industrielle Buchbinderei/Publ.: Verlag Beruf+Schule, Itzehoe 2001/Chap. 4.3.2.2, pp.: 351 ff.] describes three-knife cutting machines in which the three-sided trim takes place in a cutting station. They carry out the knife cut in which knives operate against cutting strips in a swinging, oblique cut. The printed products, such as book blocks or paper covers for example, are automatically fed in under the knives, aligned, and fixed on a cutting table by a pressing ram. This is followed by the cutting operation, the front knife for the front trim and the two lateral knives for the head/foot trim operating in a phase-offset manner. The trimmed printed products are discharged by a delivery mechanism and fed out of the machine on a conveyer belt. Because of their cuts which take place successively in time, three-cutter machines of this constructional type are limited in their cyclical output. The cutting table and pressing ram have to be adapted for each printed product format to be trimmed, as a result of which a multitude of alternating parts has to be supplied and changes of format give rise to considerable outlay. Because of the single-station principle, the mode of construction is a protruding, heavy one.

Trimmers based on the shearing-cut principle, in which an upper knife operates against a lower knife and, in the process, shears off the material to be cut against the said lower knife, are used chiefly for wire saddle-stitched paper covers. The three-sided trimming takes place in two stations, the head and foot trims taking place simultaneously before or after the front trim. With trimmers, very high cyclical outputs can be achieved. Trimmers in which cutting takes place with the printed product at a standstill are known and in widespread use. CH 340 479 describes a trimmer of this type. By means of entraining chains and/or upper and lower transporting bands which clamp-in the printed products, the said printed products which are to be trimmed are conveyed through the trimmer with the back foremost, one transporting system terminating before the front-trimming station, and a second beginning after it. Since the conveyer apparatuses are located between the cutting planes of the head/foot-trimming station and are supplemented by means for aligning the printed products in the cutting positions, the cutting units for the head, foot and front trims are designed as compact units, as can be seen from U.S. Pat. No. 3,722,336. The constructional outlay for accommodating the many functional elements is high. The thickness of the material to be cut and the quality of the cut are limited by the shearing-cut principle and are substantially lower than when cutting by the knife-cut principle.

DE 12 58 826 describes a trimmer in which the printed products are continuously gripped by a conveyer apparatus consisting of an endlessly circulating chain and tongs, and are conveyed through the cutting stations in a continuous conveying flow. The said cutting stations are disposed on carriages which oscillate in the direction of conveyance of the printed products and are moved synchronously with the conveying movement of the printed products during the cutting operations. On account of the front-trimming station, which is disposed transversely to the direction of conveyance, the circulating chains of the conveyer apparatus are guided outside the cutting region of the said station, and thereby also outside the head/foot-trimming station, the tongs fastened thereto running through the cutting planes. As a result of this, the structure of the cutting units becomes a protruding and heavy one.

Also known are two-station, three-cutter machines based on the knife-cut principle. EP 1 132 183 A1 indicates such a three-cutter machine, in which the printed product to be trimmed is clamped-in at the back in an aligned manner by a gripper that travels forward and back, and the said product is brought successively, with the front cut foremost, into two cutting positions for performing the head/foot trim and, finally, the front trim. In a manner similar to the trimmer, the printed product is pressed, during the cutting operation, along the cutting lines by pressing strips onto table elements which are disposed in a suitably opposed manner. The cutting units for the head, foot and front trims are designed as compact units. Structurally expensive conveyer apparatuses and aligning means inside the cutting stations are not necessary. The conveying of the printed products with the front cut foremost proves to be critical with respect to product quality. The cyclical output is low on account of the gripper which travels forward and back.

In two-station, three-cutter machines or two-station trimmers having cutting stations, which are disposed one behind another in a direction of conveyance, for the front and head/foot trims, it has hitherto not been possible, on account of the cutting plane, which lies perpendicularly to the direction of conveyance, of the front trim, to provide a single, continuous transporting system which clamps-in the printed products and conveys them in one direction and which is disposed between the cutting planes of the head/foot-trimming station.

### SUMMARY OF THE INVENTION

The object of the invention is to provide a device of the aforesaid type which, with a compact mode of construction of the cutting units, conveys the printed products into the front-trimming station in a clamped-in manner and with the back foremost.

This object is achieved through the invention in a surprisingly simple and economical manner. In order to achieve a compact mode of construction of the cutting units, the transporting system is disposed between the cutting planes of the head/foot-trimming station. The printed products are clamped-in at the back by a gripper and conveyed into the front-trimming station with the back foremost, the said gripper travelling through that cutting plane of the front-trimming station which lies perpendicularly to the direction of conveyance. In the process, the cutting table, which can be moved to and fro, frees the transporting path of the gripper. The printed products are thereby brought into the front-trimming position in the aligned location. Realignment is not necessary, as a result of which the structural outlay is once again simplified. The direction of conveyance of the printed products with the back foremost is of advantage for the quality of the trimmed printed products and also for the functional reliability of the device.

In a refinement, the cutting table, which is moved to and fro, is expediently designed as a one-piece cutting table and is displaced transversely to the direction of conveyance of the printed products until the transporting path of the gripper is free. In an alternative refinement, the cutting table is divided in two and at least one part of the said cutting table is displaced. The opening and closing stroke of the cutting strip thereby becomes minimal.

The device according to the invention allows the use of a circulating transporting system equipped with a plurality of grippers. Once they have been taken over by the grippers in the feeding-in system in an aligned manner, the printed products are conveyed, without being released, through the individual cutting stations and are given up again only in the feeding-out system. As a result of this, high cyclical outputs are realised with, at the same time, a structurally simple mode of construction. In yet another refinement, use is made of a transporting system which reciprocates through forward and back stop limits and in which grippers convey the printed products forward by one position at a time and, during the cutting operations, travel back into their starting position in a lowered position underneath the printed products and, in the case of the front-trimming station, underneath the cutting table, for the purpose of conveying the succeeding printed products. Under these circumstances, the grippers release the printed products only when they have been taken over by the cutting stations.

In a further refinement, the head/foot trim takes place first and, finally, the front trim. The device according to the invention is preferably refined by means of a centering device which is associated with the cutting table of the front-trimming station and which ensures, via a driving device which generates a closing force, that the cutting strip or the lower knife of the cutting table is brought into, and kept in, a precise position for the front trim.

In a preferred embodiment, the invention finds its application in a two-station, three-cutter machine based on the knife-cut principle, as a result of which the high cutting quality and cutting height thereof also becomes available for higher cyclical outputs with a simple and compact structure. Alternatively, the invention is used in a trimmer operating on the shearing-cut principle, as a result of which, in this case as well, a simple and compact structure is made possible.

### BRIEF DESCRIPTION OF THE DRAWING

The invention will be explained in greater detail below with the aid of exemplified embodiments and with reference to the accompanying drawing, in which:

FIG. 1 shows, in a perspective view, a device for the three-sided trimming of printed products, the said device being shown at a point in time at which the trim is carried out on the sides of the said printed products.

FIG. 2 shows, in the same view as in FIG. 1, the device at a point in time at which the printed products are being transported into the next station in each case.

FIG. 3 shows, in another perspective representation, details of the cutting table of the front-trimming station, at a point in time as represented in FIG. 2.

FIG. 4 shows an alternative embodiment wherein a one-piece cutting table has lower knives and the transport system reciprocates to convey the printed products one position at a time.

### DESCRIPTION OF THE PREFERRED EMBODIMENTS

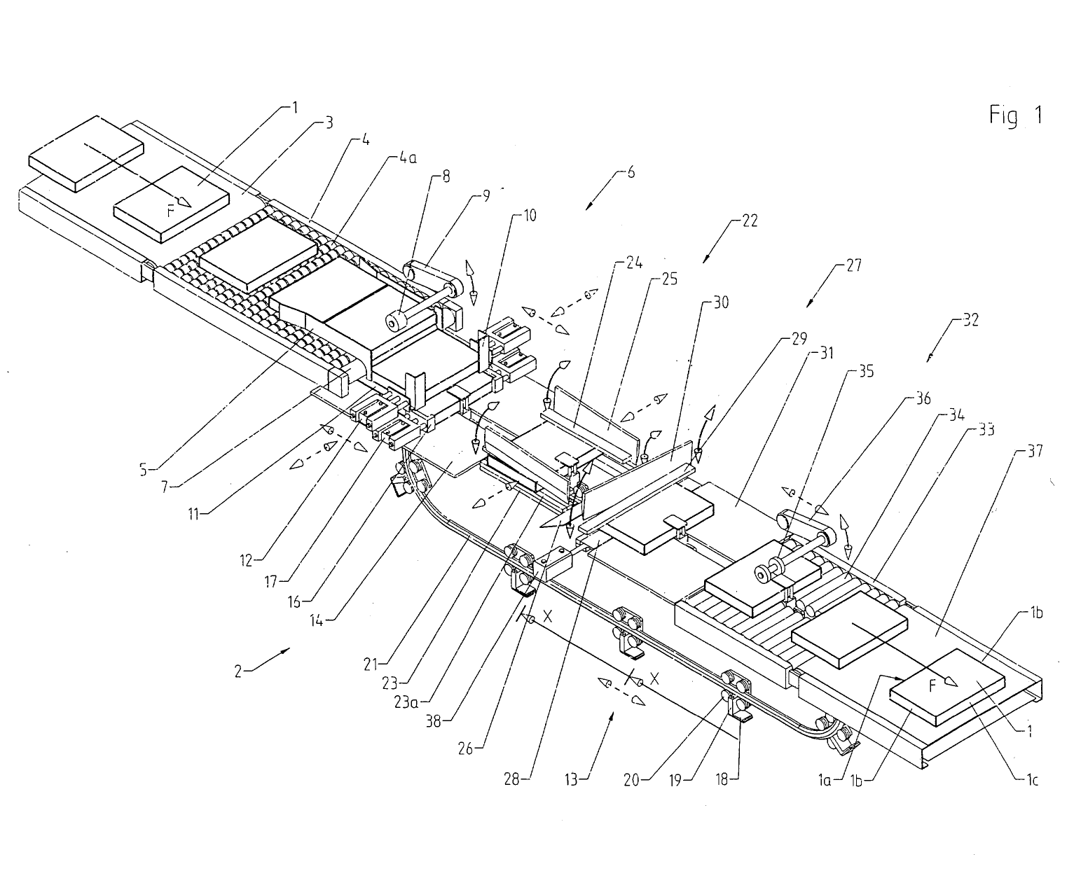

In the device 2 shown in FIGS. 1 to 3 for the three-sided trimming of printed products 1, such as book blocks, adhesively bound or wire saddle-stitched paper covers and the like, the three-sided trimming takes place based on the knife-cut principle. The printed products 1 are fed, lying flat and with the back 1c foremost (i.e., forward), via a conveyer belt 3 to a storage conveyer 4 formed from a multitude of transporting rollers 4a. At the front end of the said storage conveyer, the printed products 1 are pre-aligned by metal run-in and guide plates 5 disposed along the direction of conveyance F. The foremost printed product 1 on the storage conveyer 4 in each case is passed on in a cyclically accurate manner to a feeding-in system 6 with the aid of an accelerating roll 7 and a tipper roller 8 which is moved to and fro on a pivoting arm 9.

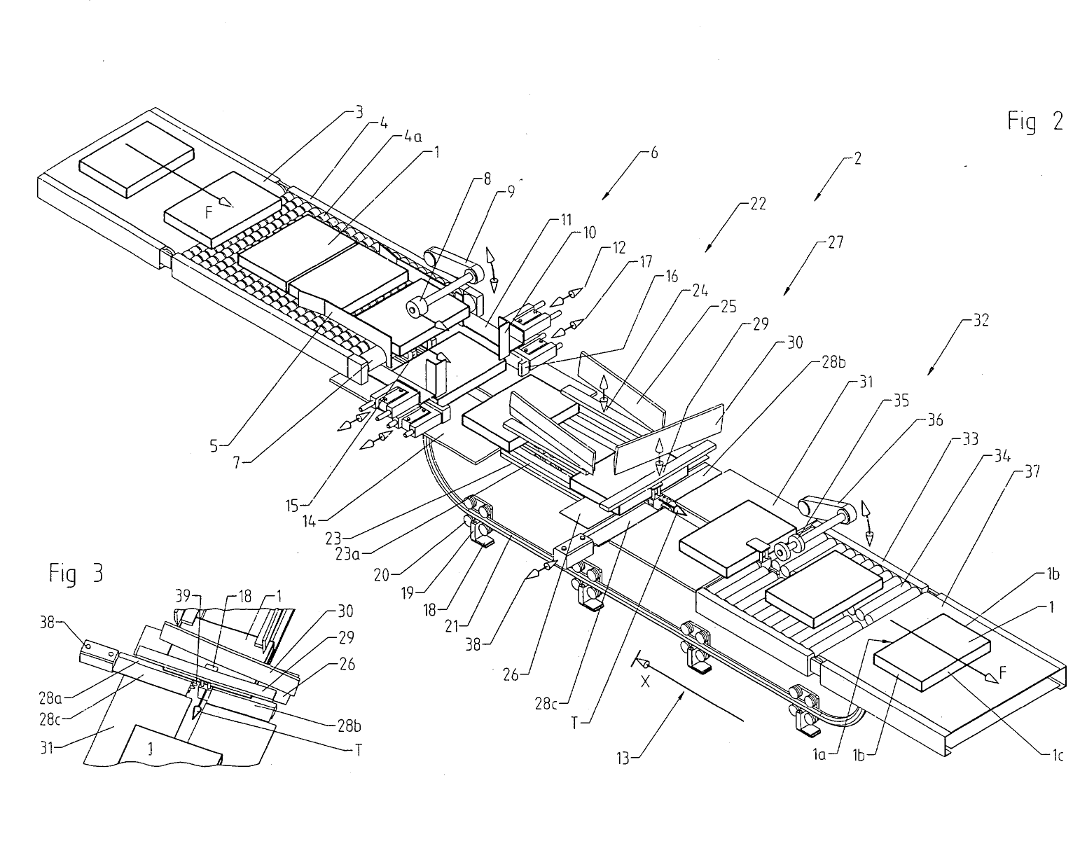

There, the printed products 1 rest, first of all, on intermediate metal plates 11. Stops 10 ensure the necessary alignment. In the next step, the intermediate metal plates 11 are pulled out sideways, by guiding and driving units 12 associated with them, under the printed products 1, as can be seen in FIG. 2, and the said printed products 1 pass onto a metal supporting plate 14 on which they are pushed in the direction of conveyance F against aligning elements 16 via aligning pushers 15 acting on the front cut 1a. In the process, the printed products 1 are also aligned transversely to their direction of conveyance F by suitable aligning movements of the aligning elements 16. The pushing-forward of the printed products 1 against the aligning elements 16 takes place only after a gripper 18 has been moved into the take-over position. The said gripper then takes over the aligned printed product 1 and conveys it in the same direction of conveyance F and onwards, in a continuously gripped manner, through the cutting stations 22 and 27 and as far as the feeding-out system 32. When conveyance out of the feeding-in system 6 takes place, the aligning elements 16 are moved to the side by guiding and driving units 17 associated with them. The double arrows shown in FIG. 1 and drawn in dotted lines symbolise the possibilities of readjustment of the guiding and driving units 12 and 17, and thereby of the intermediate metal sheets 11 and aligning elements 16, as a result of which the feeding-in system 6 can be set to the most diverse formats of the printed products 1.

The transporting system 13 consists of a multitude of grippers 18 which are disposed one behind another at an interval X and are associated, in each case, with a transporting carriage 19 which is guided in a circulating manner on a common, endless guide track 21 via running rollers 20. The transporting carriages 19 are moved forwards intermittently, with the stroke X, by driving elements, such as link chains, toothed belts or the like which are not represented, in accordance with the movement-indicating arrows in the Figures. The holding positions of the grippers 18 can be set, in accordance with the readjustment-indicating arrow drawn in dotted lines in FIG. 1, in relation to the breadth of format of the printed products 1 in such a way that the front trim always takes place at the same point and thus the front-trimming station 27 does not have to be readjusted along the direction of conveyance F. FIG. 1 shows the device 2 at a point in time at which the trimming of the printed products 1 is being carried out. The transporting system 13 is located at a standstill during this process, whereas in FIG. 2 it is conveying the printed products 1 into the next position in each case, with the stroke X.

From the feeding-in system 6, the printed products 1 are first of all fed to the head/foot-trimming station 6, which consists of two cutting units disposed along the direction of conveyance F for simultaneously trimming the head 1b and foot 1b. The printed products 1 rest on cutting tables 23 which are disposed along the cutting lines and receive cutting strips 23a, and the said products are held down and pressed, particularly along the cutting lines, by pressing strips 24. The head and foot knives 25 then execute the knife cut against the cutting strips 23a in an oblique, swinging cut. The movement of the head and foot knives 25 is represented symbolically in FIG. 1 by movement-indicating arrows. The cutting units of the head/foot-trimming station 22 are re-adjustable according to the height of the format of the printed products 1, as is represented symbolically by the readjustment-indicating arrows in FIG. 1.

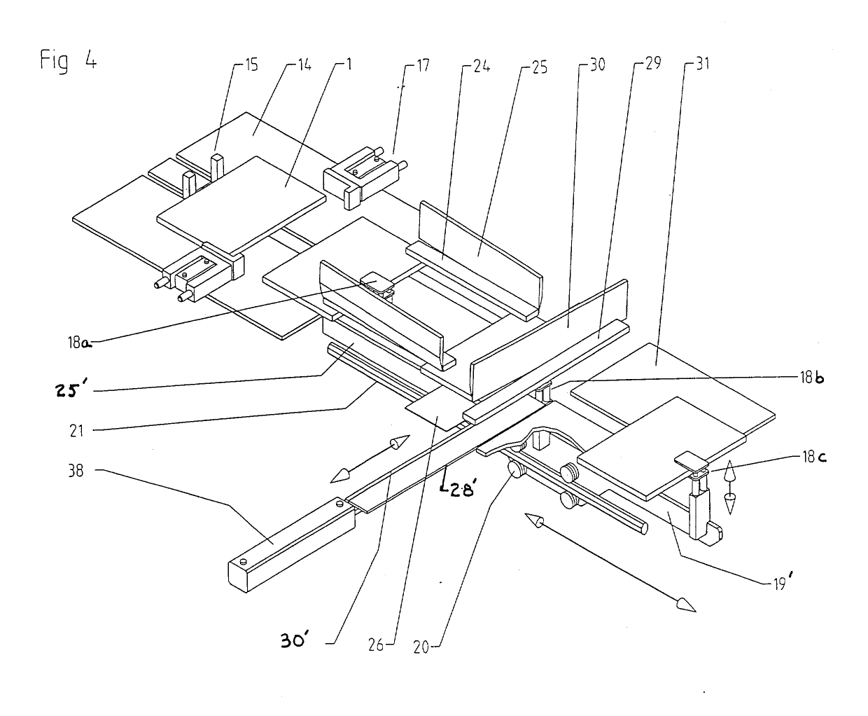

The next position of the printed products 1 is the front-trimming station 27, into which the said printed products 1 are pulled, via a metal transferring plate 26, by the gripper 18. The front trim is effected by the front knife 30 which trims, in a swinging, oblique cut at the front cut 1a, the printed products 1 which are pressed, at least along the cutting line via a pressing strip 29, against a cutting table 28 provided with a cutting strip 28a. The cutting table 28 of the front-trimming station 27 is divided in two into a stationary cutting-table part 28b and a movable cutting-table part 28c. The latter is guided in a linear manner transversely to the direction of conveyance F of the printed products via guiding elements which are not shown here, and is moved to and fro by a pneumatic cylinder 38 into a position which opens the transporting path T of the grippers 18 and into a position which closes the cutting strip 28. In FIG. 3, this area is represented in another perspective view of the device 2. It will be perceived how the gripper 18 travels along the transporting path T and into the front-trimming station 27 through the opening in the cutting table 28. In the closing position, the movable cutting-table part 28c is held, via a centring system 39 in the form of conical fitting pins, for example, and by the closing force of the pneumatic cylinder 38, in a precise position in relation to the stationary cutting-table part 28b.

So that the cutting waste can drop freely downwards in the front-trimming station 27, the metal transferring plate 26 is tipped upwards during the cutting operation and is pivoted back into the plane of conveyance again for the onward transport of the printed products 1. The said printed products 1 which have been finish-trimmed on the three sides—head 1b, foot 1b and front cut 1a—are last of all transferred by the transporting system 13 into the feeding-out system 32, which consists of an intermediate conveyer 33 having a multitude of conveyer rolls 34 and of a tipping roller 35 which can be moved up and down via a pivoting arm 36. When the printed products 1 are at a standstill, the tipping roller 35 alights on the printed product 1 to be conveyed out, and holds it in this position until the particular gripper 18 has opened and has removed itself from the said printed product 1 forwards and then downwards in the next conveying step. The said printed product is then transported onwards in an accelerated manner and delivered up to a conveyer belt 37 which feeds the printed products 1 to other processing stations.

As shown in FIG. 4, the invention can likewise be used on a trimmer which operates on the shearing-cut principle and in which the cutting knives 25, 30 for the head and foot and for the front operate against stationary lower knives 25′ and 30′, respectively, in a vertical movement. This embodiment also has a one piece cutting table 28′ with the lower knife 30′ in the front cutting station. The transport system 19′ of this embodiment has three grippers 18a, 18b, and 18c on a carriage that reciprocates between forward and rear stop positions. The first gripper 18a transports the product into the head/foot trimming station. The second gripper 18b transports the product from the head/foot trimming station into the front-trimming station while the pneumatic cylinder 38 opens the transport path of that gripper. The cutting table of the front-trimming station of the trimmer, to which table the lower knife 30′ is fastened, is displaced transversely to the direction of conveyance F of the printed products until the transporting path T of the gripper 18b is freed. At the same time, the third gripper 18c transports the (trimmed) product out of the front-trimming station. During the cutting operations the transporting carriage with the grippers travels back to the starting position with the grippers lowered, preparatory to conveying succeeding products.

1. Device for the three-sided trimming of book blocks, adhesively bound or wire saddle-stitched paper covers and like printed products (1), the said device having separate cutting stations (22, 27), which are disposed one behind another in a direction of conveyance (F), for the front and head/foot trims, the said direction of conveyance (F) being orientated perpendicularly to the height of the block and perpendicularly to the front-trimming plane; having cutting tables (23, 28) on which the printed products (1) rest, at least partially, during trimming; having knives (25, 30) which are moved up and down and which operate against cutting strips (23a, 28a) fixed in the cutting tables (23, 28) or against lower knives; having pressing beams (24, 29) for pressing the printed products (1) against the cutting tables (23, 28); and having a transporting system (13) which connects at least the two cutting stations (22, 27) and clamps-in the printed products (1) in the process, wherein the improvement comprises a gripper (18) belonging to the transporting system (13), which gripper grasps the printed products (1) at the back (1c) and transports them with the back (1c) foremost, is guided in a plane between the cutting planes of the head/foot-trimming station (22) and effects conveyance through the cutting plane of the front-trimming station (27); and by a cutting table (28, 28a) which is associated with the front-trimming station (27) and can be moved to and fro and which frees the transporting path (T) of the gripper (18) during the transporting of the printed products (1) into the front-trimming station (27).

2. Device according to claim 1, comprising a cutting table (28) belonging to the front-trimming station (27), which cutting table is in one piece and can be moved to and fro, transversely to the direction of conveyance (F), for the purpose of freeing the transporting path (T) of the gripper (18).

3. Device according to claim 1, comprising a cutting table (28, 28b, 28c) which is divided in two and, with it, a cutting strip (28a) or lower knife, which is divided in two, belonging to the front-trimming station (27), and by a to-and-fro movement, which is directed transversely to the direction of conveyance (F), of at least one part (28c) of the cutting table (28) in such a way that a transporting path (T) for the gripper (18) is opened during the transporting of the printed products (1).

4. Device according to claim 1 comprising a transporting system (13) having a plurality of circulating grippers (18), in which transporting system the printed products (1) are taken over by the grippers (18) in a feeding-in station (6) which aligns the said printed products, are held in a continuously gripped manner during onward transport and the cutting operations, and are given up again in a feeding-out system (32).

5. Device according to claim 1 comprising a transporting system (13) having one or more grippers (18) which travel forward and back and convey the printed products (1) onwards by one position at a time and which, during the cutting operations, travel back into their starting location in a lowered position underneath the printed products (1) and, optionally, underneath the cutting table (28) of the front-trimming station (27), for the purpose of conveying the succeeding printed products (1).

6. Device according to claim 1 wherein the head/foot trim takes place first and, after that, the front trim.

7. Device according to claim 1 comprising a centering device (39) which is associated with the cutting table (28) of the front-trimming station (27), and by a driving device (38) which generates a closing force when the cutting table (28) is closed, as a result of which the cutting strip (28a) or the lower knife of the cutting table (28) is brought into, and kept in, a precise position for the front trim.

8. Device according to claim 1 wherein the three-sided trimming of the printed products (1) takes place according to the knife-cut principle, in which knives (25, 30) operate against cutting strips (23a, 28a) in a swinging, oblique cut.

9. Device according to claim 1 wherein the three-sided trimming of the printed products (1) takes place according to the shearing-cut principle, in which knives (25, 30) operate against lower knives and, in the process, shear off the material to be cut against the said lower knives.

10. Device for the three-sided trimming of printed products (1) having a front side and opposite back side spaced by the width of the product, and a head side and a foot side spaced apart by the height of the product, wherein said device has
separate cutting stations (22, 27), which are disposed serially in a direction of product conveyance (F), for trimming the front side along a front-trimming plane and the head and foot sides along respective head and foot trimming planes, said direction of conveyance (F) being orientated perpendicularly to said height and perpendicularly to the front-trimming plane;
separate cutting tables (23, 28) associated respectively with said cutting stations on which the printed products (1) rest, at least partially, during trimming;
cutting means (25, 30) which are moved up and down;
pressing beams (24, 29) for pressing the printed products (1) against the cutting tables (23, 28);
a transporting system (13) spanning at least the two cutting stations (22, 27) and clamping-in the printed products (1)as they are conveyed through the cutting stations,
wherein the improvement comprises:
a gripper (18) in the transporting system (13), which gripper grasps the printed products (1) at the back end (1c) and transports the products along a transporting path with the back end (1c) foremost;
means for guiding the gripper in a plane between the head and foot trimming planes and effecting conveyance through the front-trimming plane(27); and
said cutting table (28, 28a) which is associated with the front-trimming station (27) being movable reciprocally into and out of the transporting path (T) of the gripper (18) during the transporting of the printed products (1) into the front-trimming station (27).

11. Device according to claim 10, wherein at least a portion of the cutting table associated with the front trimming station, reciprocates transversely to the direction of conveyance (F), for the purpose of freeing the transporting path (T) of the gripper (18).

12. Device according to claim 10, wherein the cutting table associated with the front trimming station (28, 28b, 28c) has a portion oriented transversely to the direction of conveyance (F) for cooperating with the front side trimming knife, which portion is divided into parts such that at least one part (28c) reciprocates in such a way that a transporting path (T) for the gripper (18) is open between the parts during the transporting of the printed products (1) onto the cutting table before trimming and closed during the trimming of the front side.

13. Device according to claim 10,
including means for aligning the printed products at a feeding in station (6) upstream of the cutting stations,
wherein the a plurality of circulating grippers (18), grasp respective aligned printed products (1) in the feeding-in station and continuously grasp the products during transport through both cutting stations.

14. Device according to claim 10, wherein the transporting system (13) has at least one gripper (18) which travels forward and back and conveys the printed products (1) onwards by one position at a time and which, during the cutting operations, travel back into their starting location in a lowered position underneath the printed products (1) for the purpose of conveying the succeeding printed products (1).

15. Device according to claim 10, wherein the head and foot trim takes place first at one cutting station and, after that, the front trim takes place at the other cutting station.

16. Device according to claim 10 wherein a centering device (39) is associated with the reciprocating cutting table (28) of the front-trimming station (27), for precisely positioning the reciprocating table relative to the knife.

17. Device according to claim 10 wherein the knives (25, 30) operate in a swinging, oblique cutting action against cutting strips (23a, 28a) in the cutting tables.
